(19) United States
(12) Patent Application Publication
(10) Pub. No.: US 2011/0249478 A1
(43) Pub. Date: Oct. 13, 2011

(54) POWER OUTPUT STAGE FOR A PULSE-CONTROLLED INVERTER

(76) Inventors: Jochen Kuehner, Backnang (DE); Albrecht Schwarz, Rutesheim (DE)

(21) Appl. No.: 13/125,032

(22) PCT Filed: Sep. 18, 2009
(86) PCT No.: PCT/EP2009/062094

§ 371 Date: Jun. 27, 2011

(30) Foreign Application Priority Data
Oct. 22, 2008 (DE) 10 2008 043 043.9

(51) Int. Cl. H02M 7/537

(52) U.S. Cl. 363/131

(57) ABSTRACT

A power output stage for a pulse-controlled inverter includes a half-bridge. The half-bridge has a control terminal and power terminals. The power terminals include a terminal for a positive supply voltage, a terminal for a negative supply voltage and a phase voltage terminal. In particular, the power output stage has two half-controlled half-bridges, whose power terminals are connected in parallel, and whose control terminals are not connected to one another.

### FIELD OF THE INVENTION

The present invention relates to a power output stage for a pulse-controlled inverter.

### BACKGROUND INFORMATION

It is known that pulse-controlled inverters may be used in industrial drives, in hybrid vehicles and in electric vehicles, for example. Such pulse-controlled inverters have power output stages, which are implemented using semiconductor switches. IGBT half-bridges are often used with known power output stages.

FIG. 1 shows one example of a known IGBT half-bridge. The IGBT half-bridge shown there has control terminals S1 and S2, a first IGBT T1, a second IGBT T2, a first diode D1, a second diode D2, and power terminals plus, phase, and minus. Power terminal plus is a terminal for a positive supply voltage;

power terminal phase is a phase voltage terminal, and power terminal minus is a terminal for a negative supply voltage.

The gate of IGBT T1 is connected to control terminal S1. The gate of IGBT T2 is connected to control terminal S2. Control terminals S1 and S2 are supplied with control signals by a control unit (not shown).

The collector of IGBT T1 is connected to power terminal plus, and the emitter of IGBT T1 is connected to power terminal phase. In addition, a diode D1, whose anode is connected to power terminal phase and whose cathode is connected to power terminal plus, is provided between power terminal phase and power terminal plus.

The collector of IGBT T2 is connected to power terminal phase, the emitter of IGBT T2 is connected to power terminal minus. In addition, a diode D2, whose anode is connected to power terminal minus and whose cathode is connected to power terminal phase, is provided between power terminal minus and power terminal phase.

In addition, it is already known that a plurality of half-bridges may be connected in parallel to supply higher output currents. FIG. 2 shows one example of such a parallel circuit of two half-bridges HB1, HB2.

Half-bridge HB1 has control terminals S1 and S2, a first IGBT T3, a second IGBT T4, a first diode D3, a second diode D4, and power terminals plus, phase, and minus.

The gate of first IGBT T3 is connected to control terminal S1, and the gate of IGBT T4 is connected to control terminal S2. The collector of first IGBT T3 is connected to power terminal, plus, and the emitter of first IGBT T3 is connected to power terminal phase. In addition, a diode D3, whose anode is connected to power terminal phase and whose cathode is connected to power terminal plus, is provided between power terminal phase and power terminal plus.

The collector of second IGBT T4 is connected to power terminal phase and the emitter of second IGBT T4 is connected to power terminal minus. In addition, a diode D4, whose anode is connected to power terminal minus and whose cathode is connected to power terminal phase, is provided between power terminal minus and power terminal phase.

Half-bridge HB2 is connected in parallel to half-bridge HB1 with respect to the control terminals and the power terminals. A first control terminal of second half-bridge HB2 is thus connected to control terminal S1 of first half-bridge HB1, and a second control terminal of second half-bridge HB2 is connected to control terminal S2 of the first half-bridge. In addition, second half-bridge HB2 has a third IGBT T5, a fourth IGBT T6, a third diode D5, a fourth diode D6, and power terminals plus, phase, and minus, each of these power terminals being connected to a corresponding power terminal of the first half-bridge.

The gate of third IGBT T5 is connected to control terminal S1, and the gate of fourth IGBT T6 is connected to control terminal S2. The collector of third IGBT T5 is connected to power terminal plus, and the emitter of third IGBT T5 is connected to power terminal phase. In addition, a diode D5, whose anode is connected to power terminal phase and whose cathode is connected to power terminal plus, is provided between power terminal phase and power terminal plus.

The collector of fourth IGBT T6 is connected to power terminal phase, and the emitter of fourth IGBT T6 is connected to power terminal minus. In addition, a diode D6, whose anode is connected to power terminal minus and whose cathode is connected to power terminal phase, is provided between power terminal minus and power terminal phase.

With such a parallel circuit of a plurality of half-bridges, equalizing currents and oscillations may occur and may have a severely impairing effect on the switching performance of the IGBTs and may even cause the destruction of one or more IGBTs.

### SUMMARY

A power output stage having the features described herein has the advantage over the related art that equalizing currents and oscillations, which may impair the switching performance of the IGBTs and may even cause the destruction of one or more IGBTs, no longer occur due to the use of half-controlled half-bridges. This advantage is attributed to the fact that the control terminals of the IGBTs are no longer connected in parallel, in contrast with the related art. Consequently, no ground loops may occur.

Another advantage is that only one IGBT is provided per half-controlled half-bridge used. Since fewer components are needed on the whole, the required components may be designed to be larger.

Another advantage is that only the control lines of one IGBT need be carried to an external terminal. Consequently, a larger IGBT area may be achieved without a parallel circuit of the control terminals.

Yet another advantage is given on the basis of the lower parasitic inductances. Parasitic inductances generate overvoltages during switching operations of the half-bridges of a power output stage. These overvoltages are reduced when using half-controlled half-bridges.

Additional advantageous properties of example embodiments of the present invention are derived from its explanation below on the basis of the additional drawings.

### BRIEF DESCRIPTION OF THE DRAWINGS

FIG. 3 shows a diagram of two interconnected half-controlled half-bridges according to an example embodiment of the present invention, and

FIG. 4 shows a diagram illustrating the curve of a phase current and its distribution among the components of the half-controlled half-bridges.

### DETAILED DESCRIPTION

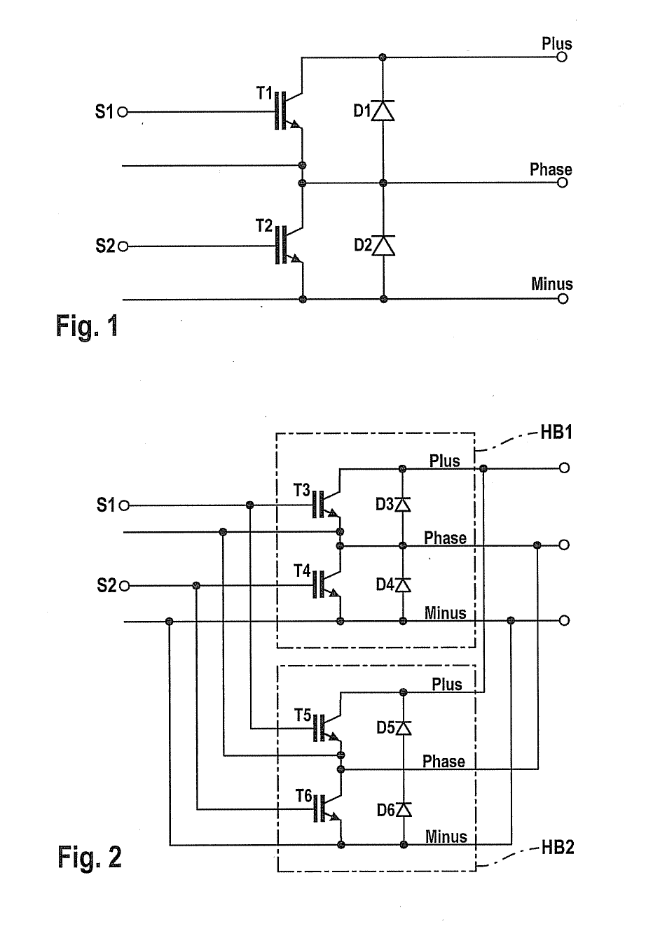

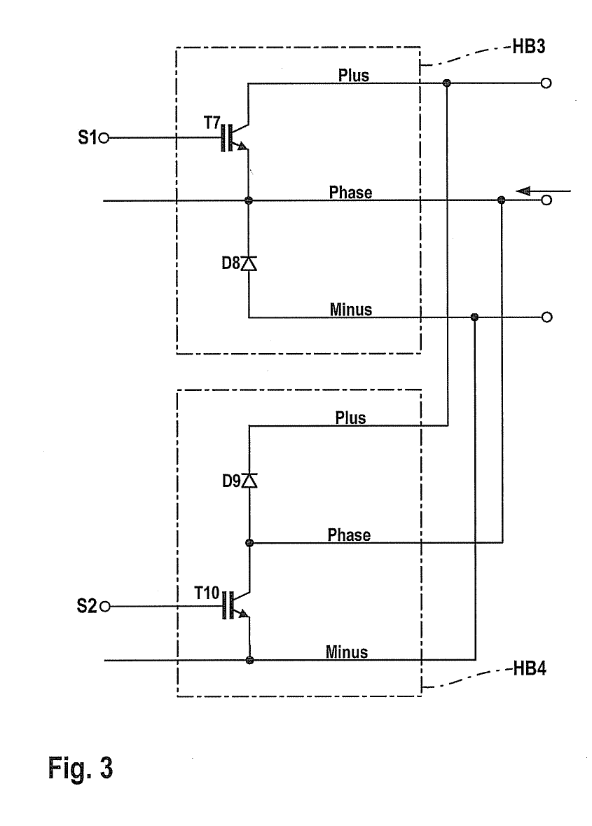

FIG. 3 shows a diagram of two interconnected half-controlled half-bridges HB3, HB4 according to an example embodiment of the present invention. Half-bridge HB3 has a control terminal S1, a single IGBT T7, a diode D8 and power terminals plus, phase, and minus.

The gate of IGBT T7 is connected to control terminal S1, and the collector of IGBT T7 is connected to power terminal plus. The emitter of IGBT T7 is connected to power terminal phase. Diode D8 is switched between power terminal minus and power terminal phase, the anode of diode D8 being connected to power terminal minus and the cathode of diode D8 being connected to power terminal phase.

Half-bridge HB4 has a control terminal S2, a single IGBT T10, a diode D9 and power terminals plus, phase and minus. The gate of IGBT T10 is connected to control terminal S2, and the collector of IGBT T10 is connected to power terminal phase. The emitter of IGBT T10 is connected to power terminal minus. Diode D9 is switched between power terminal phase and power terminal plus, the anode of diode D9 being connected to power terminal phase and the cathode of diode D9 being connected to power terminal plus.

Power terminal plus of first half-bridge HB3 is connected to power terminal plus of second half-bridge HB4.

Power terminal phase of first half-bridge HB3 is connected to power terminal phase of second half-bridge HB4. Power terminal minus of first half-bridge HB3 is connected to power terminal minus of second half-bridge HB4. Consequently, the power terminals of second half-bridge HB4 are each connected to a corresponding power terminal of the first half-bridge. This corresponds to a parallel circuit of the power terminals of the two half-bridges. Control terminals S1 and S2 of the two half-bridges are not interconnected. Each of the two half-bridges is a half-controlled half-bridge because the diode of the particular half-bridge used as a switching element is not an externally controlled component. As a result, only a single control terminal is needed per half-bridge.

The half-controlled half-bridges described above may be used, for example, in inverters in hybrid vehicles and in electric vehicles. The advantages of such half-controlled half-bridges include in particular the fact that they do not have any control terminals connected in parallel, so that an occurrence of ground loops is prevented. In addition, a larger chip area is possible in comparison with the related art. Furthermore, the wiring complexity of the half-bridges within each half-bridge and also with respect to the external terminals of the particular half-bridge is reduced. Furthermore, smaller effective parasitic inductances occur in comparison with the related art, in which the IGBTs each have diodes connected in parallel.

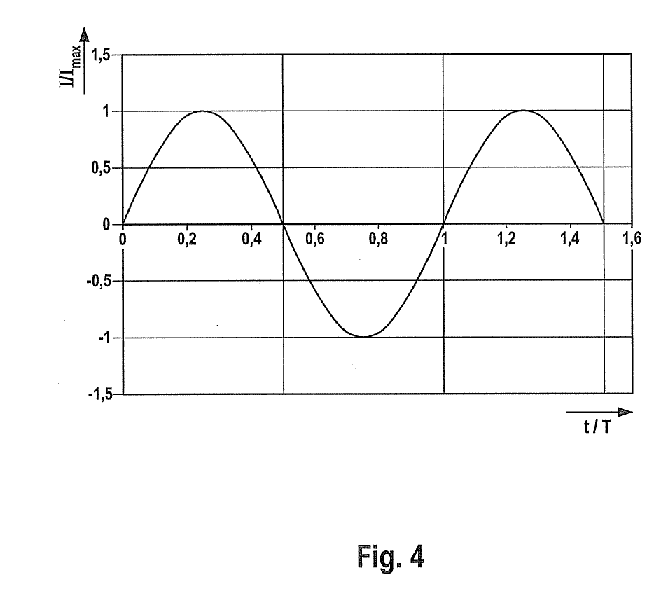

FIG. 4 shows a diagram illustrating the curve of the phase current flowing across the phase terminal of a half-bridge and its distribution among the components of the corresponding half-controlled half-bridge. In this diagram, the I_{Phase}/I_{Max} ratio is plotted on the ordinate and time t/T is plotted on the abscissa. It is apparent here that the phase current has a sinusoidal curve, alternating only between the IGBT and the diode of the particular half-bridge. Only at a zero crossing of the phase current is there a current change from one half-bridge to the other. Current thus flows through transistor T10 and diode D9 during the first positive half-wave between t/T=0 and t/T=0.5 in the exemplary embodiment shown here; current flows through transistor T7 and diode D8 during the first negative half-wave between t/T=0.5 and t/T=1, and current again flows through transistor T10 and diode D9 during the second positive half-wave between t/T=1 and t/T=1.5.

Consequently, only the parasitic inductances act within a half-bridge. These parasitic inductances are much smaller than the parasitic inductances which would occur in the connections between two half-bridges.

1-8. (canceled)

9. A power output stage for a pulse-controlled inverter, comprising:
a half-controlled half-bridge.

10. The power output stage according to claim 9, wherein the half-controlled half-bridge has a control terminal and power terminals.

11. The power output stage according to claim 10, wherein the power terminals include a terminal for a positive supply voltage, a terminal for a negative supply voltage and a phase voltage terminal.

12. The power output stage according to claim 11, wherein the half-controlled half-bridge has a single IGBT having a gate connected to the control terminal, having a collector connected to the terminal for the positive supply voltage and having an emitter connected to the phase voltage terminal.

13. The power output stage according to claim 11, wherein the half-controlled half-bridge has a single diode, having an anode connected to the terminal for the negative supply voltage and having a cathode connected to the phase voltage terminal.

14. The power output stage according to claim 9, further comprising another half-controlled half-bridge, having power terminals each connected to a corresponding power terminal of the half-controlled half-bridge.

15. The power output stage according to claim 14, wherein the additional half-controlled half-bridge has a single IGBT, having a gate connected to another control terminal, having a collector connected to a phase voltage terminal and having an emitter connected to a power terminal.

16. The power output stage according to claim 14, wherein the additional half-controlled half-bridge has a single diode, having an anode connected to a phase voltage terminal and having a cathode connected to a power terminal.
